(19) United States
(12) Patent Application Publication
(10) Pub. No.: US 2016/0048064 A1
(43) Pub. Date: Feb. 18, 2016

(54) Display Apparatus

(71) Applicant: SAKAI DISPLAY PRODUCTS CORPORATION, Osaka (JP)

(72) Inventor: Hidetoshi Nakagawa, Sakai-shi, Osaka (JP)

(21) Appl. No.: 14/782,129

(22) PCT Filed: May 26, 2014
(86) PCT No.: PCT/JP2014/063868

§ 371 Date: Oct. 2, 2015

(30) Foreign Application Priority Data
May 28, 2013 (JP) 2013-112248

(51) Int. Cl. G02F 1/1362; G02F 1/1339; G02F 1/1333

(52) U.S. Cl. CPC G02F 1/136227; G02F 1/133345; G02F 1/1339; G02F 1/136286; G02F 2001/13629; G02F 2001/13606

(57) ABSTRACT

Provided is a display apparatus which narrows the frame of the panel to a level that the seal for bonding the substrates is not easily broken, and reduces an influence of a parasitic capacitance due to portions in which scanning lines and signal lines intersect. The display apparatus includes two substrates facing each other, a first signal line layer provided on one substrate of the two substrates, a second signal line layer provided in the first signal line layer through a plurality of first insulation layers, and a sealing body which is provided on a peripheral edge part of the one substrate through one or a plurality of second insulation layers having the number of layers less than the number of layers of the first insulation layer, and seals an opposing gap between the two substrates.

This application is the national phase under 35 U.S.C. §371 of PCT International Application No. PCT/JP2014/063868 which has an International filing date of May 26, 2014 and designated the United States of America.

### TECHNICAL FIELD

The present invention relates to a display apparatus which narrows a frame and reduces an influence of parasitic capacitance.

### DESCRIPTION OF RELATED ART

Recently, as a display apparatus for displaying an image, an active matrix type liquid crystal display apparatus which includes a switching element such as thin film transistors (TFTs) in each pixel is used. A TFT substrate used in the active matrix type liquid crystal display apparatus has one conductive layer including a plurality of scanning lines, and the other conductive layer including a plurality of signal lines which intersect the plurality of scanning lines through an insulation layer, which are formed thereon in order to define a plurality of pixel regions. The thin film transistors for switching each pixel are respectively formed in the vicinity of a portion in which the scanning line and the signal line intersect. With the definition and size of the active matrix type liquid crystal display apparatus becoming higher and larger, the number of thin film transistors formed at the portions in which the scanning lines and the signal lines intersect is also increased.

A parasitic capacitance is generated at the portion in which the scanning line and the signal line intersect, which affects the driving of the liquid crystal display apparatus, such that display quality of the liquid crystal display apparatus may be deteriorated. In addition, if the definition and size of the active matrix type liquid crystal display apparatus becomes higher and larger, the number of portions in which the scanning lines and the signal lines intersect is increased, and thereby the parasitic capacitance is also increased.

Conventionally, in order to reduce the parasitic capacitance due to the intersection portion, processing such as widening the thickness of an insulation layer formed between the scanning line and the signal line, making the insulation layer in a multi-layer structure, or the like has been executed (see Japanese Patent Application Laid-open No. 2007-225860).

### SUMMARY

FIG. 8 is a view illustrating the periphery of a region in which a seal is formed in a conventional liquid crystal panel. FIG. 8 illustrates, as described in Japanese Patent Application Laid-open No. 2007-225860, when the insulation layer formed between the scanning line and the signal line is made in a multi-layer structure, the periphery of the region in which the seal for bonding two substrates facing each other in a liquid crystal panel 1 is formed. In a direction in which the substrates face each other, an upper substrate 2 and a lower substrate 3 of a TFT substrate are bonded by a seal 10 through the insulation layer, and the upper substrate 2, the seal 10, the insulation layer and the lower substrate 3 are sequentially disposed from the top of FIG. 8. The insulation layer is a three-layer structure, and includes an interlayer insulation layer 11, a gate insulation layer 12 and an interwire insulation layer 13 which are sequentially formed from the upper substrate 2 side. In a pixel region, the interlayer insulation layer 11 is an insulation layer formed between the signal line and the upper substrate 2, and the gate insulation layer 12 and the interwire insulation layer 13 are insulation layers formed between the scanning lines and the signal lines.

When narrowing the frame of the active matrix type liquid crystal display apparatus, there is a problem related to the width formed by the seal 10 in a direction perpendicular to the direction in which the seal material is adhered, that is, in a left-right direction of FIG. 8. If simply decreasing the width of the seal 10, it is possible to narrow the frame of the liquid crystal panel. However, when narrowing the frame of the liquid crystal panel by simply decreasing the width of the seal 10, that is, decreasing the volume of the seal 10, the seal 10 may be easily broken, and a liquid crystal material sealed in a sealing region is leaked, whereby failure occurs in the apparatus. Meanwhile, it is conceivable to narrow the frame of the liquid crystal panel by decreasing the number of components formed on the lower substrate 3. However, when decreasing the number of layers of the insulation layers formed on the lower substrate 3, problems due to the parasitic capacitance by the portion in which the scanning line and the signal line intersect are highly likely to occur in the liquid crystal display apparatus. Therefore, in the conventional active matrix type liquid crystal display apparatus, it is difficult to narrow the frame and reduce the influence of the parasitic capacitance.

In consideration of the above-mentioned circumstances, it is an object of the present invention to provide a display apparatus which is capable of narrowing the frame of the panel by decreasing a seal width to a level that the seal for bonding the substrates is not easily broken, and reducing an influence of the parasitic capacitance due to a portion in which a scanning line and a signal line intersect.

According to one aspect, there is provided a display apparatus including: two substrates which face each other; a first signal line layer provided on one substrate of the two substrates; a second signal line layer provided on the first signal line layer through a plurality of first insulation layers; and a sealing body which is provided on a peripheral edge part of the one substrate through one or a plurality of second insulation layers having the number of layers less than the number of layers of the first insulation layer, and seals an opposing gap between the two substrates.

According to the display apparatus of present invention, the number of layers of the second insulation layer which is formed between the peripheral edge part of the one substrate and the sealing body is less than the number of layers of the first insulation layer which is formed between the first signal line layer and the second signal line layer.

In the display apparatus according to the present invention, the second insulation layer may be formed on the peripheral edge part of the one substrate continuing to the first insulation layer.

According to the display apparatus of present invention, the second insulation layer is continuous from the first insulation layer to the peripheral edge part of the one substrate.

In the display apparatus according to the present invention, an insulation layer which is located on the one substrate side among the first insulation layers may be formed of a spin-on-glass (SOG) material.

According to the display apparatus of present invention, the insulation layer which is located on the one substrate side among the first insulation layers is formed of the spin-on-glass (SOG) material.

In the display apparatus according to the present invention, the one substrate may be formed in a rectangular shape, and the second insulation layer may be formed along four sides of the substrate.

According to the display apparatus of present invention, the second insulation layer is formed along the four sides of the rectangular substrate.

In the display apparatus according to the present invention, the sealing body may be formed in a frame shape, and the number of layers of the first insulation layer may be more than the number of layers of the second insulation layer in the vicinity of an outer peripheral part and the vicinity of an inner peripheral part of the sealing body.

According to the display apparatus of present invention, the number of layers of the first insulation layer is more than the number of layers of the second insulation layer in the vicinity of the outer peripheral part and the vicinity of the inner peripheral part of the rectangular sealing body.

In the display apparatus according to the present invention, a ratio of a portion in which the insulation layer is removed in the vicinity of the outer peripheral part and the vicinity of the inner peripheral part of the sealing body may be 0.48% or more of an entire region formed by the sealing body.

According to the display apparatus of present invention, the ratio of the portion in which the insulation layer is removed in the vicinity of the outer peripheral part and the vicinity of the inner peripheral part of the sealing body is 0.48% or more of the entire region formed by the sealing body.

In the display apparatus according to the present invention, the second insulation layer may haves a hole formed therein to contact the sealing body with the substrate.

According to the display apparatus of present invention, the second insulation layer has the hole formed therein for contacting the sealing body with the substrate.

In the display apparatus according to the present invention, an conductive layer may be not disposed around the hole.

According to the display apparatus of present invention, an conductive layer is not disposed around the hole.

In the display apparatus according to the present invention, the first insulation layer may be formed in three layers.

According to another aspect, there is provided a display apparatus including: two substrates which face each other; a first signal line layer provided on one substrate of the two substrates; a second signal line layer provided on the first signal line layer through a plurality of first insulation layers; one or a plurality of second insulation layers provided between the second signal line layer and the other substrate; and a sealing body which is provided on a peripheral edge part of the one substrate through a third insulation layer having the number of layers less than the number of layers obtained by adding the first insulation layer and the second insulation layer, and seals an opposing gap between the two substrates.

According to the display apparatus of present invention, the number of layers of the third insulation layer formed between the peripheral edge part of the one substrate and the sealing body is less than the number of layers obtained by adding the first insulation layer which is formed between the first signal line layer and the second signal line layer and the second insulation layer which is formed between the second signal line layer and the other substrate.

According to the display apparatus of present invention, it is possible to narrow the frame of the panel by decreasing the seal width to a level that the seal for bonding the substrates is not easily broken, and reduce an influence of the parasitic capacitance due to the intersection portions of the plurality of scanning lines.

The above and further objects and features will move fully be apparent from the following detailed description with accompanying drawings.

### BRIEF DESCRIPTION OF THE SEVERAL VIEWS OF THE DRAWINGS

FIG. 1 is a plan view and a cross-sectional view of an entire liquid crystal panel according to one embodiment of the present invention.

FIG. 2A is a partial plan view taken on line A-A′ of FIG. 1 for illustrating a TFT structure, and FIG. 2B is a partial cross-sectional view taken on line A-A′ of FIG. 1 for illustrating the TFT structure.

FIG. 3 is cross-sectional views taken on line B-B′ of FIG. 1 for describing narrowing of the frame in the liquid crystal panel in the periphery of a region in which a seal is formed.

FIG. 4 is cross-sectional views for describing narrowing of the frame in a liquid crystal panel in the periphery of a seal connecting part according to another embodiment of the present invention.

FIG. 5 is views for describing the seal connecting part.

FIG. 6 is a partial plan view of a lower substrate and the seal according to another embodiment of the present invention.

FIG. 7 is a cross-sectional view taken on line A-A′ of FIG. 6 for illustrating the periphery of the region in which the seal is formed.

FIG. 8 is a view illustrating the periphery of a region in which a seal is formed in a conventional liquid crystal panel.

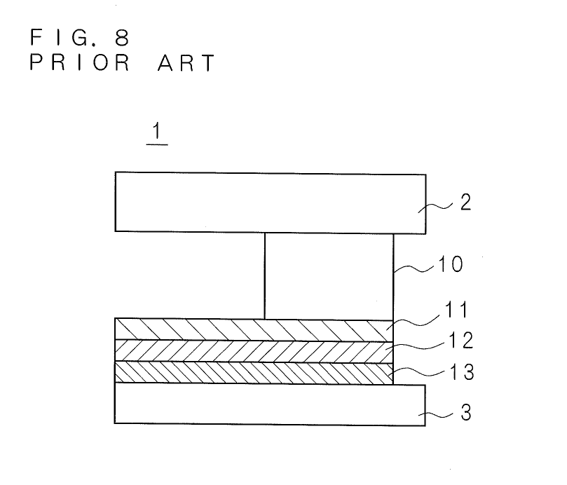

### DETAILED DESCRIPTION

Hereinafter, embodiments of the present invention will be described with reference to the accompanying drawings, but the present invention is not limited to these embodiments. Further, in the drawings to be described below, components having the same function will be denoted by the same reference numerals, and will not be repeatedly described.

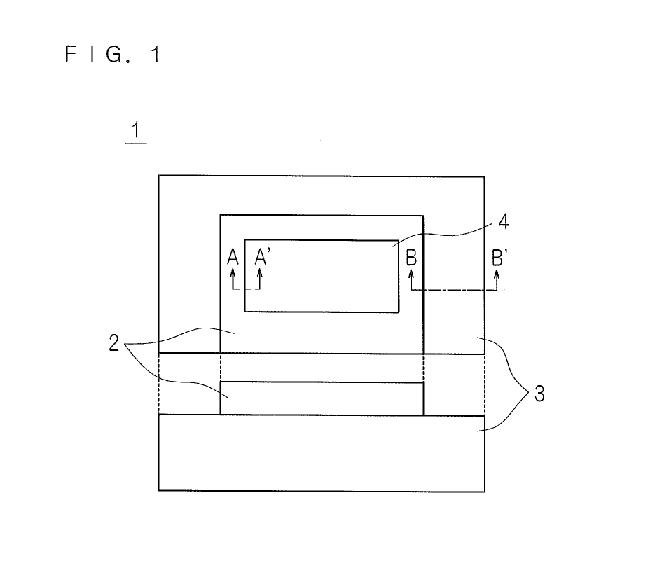

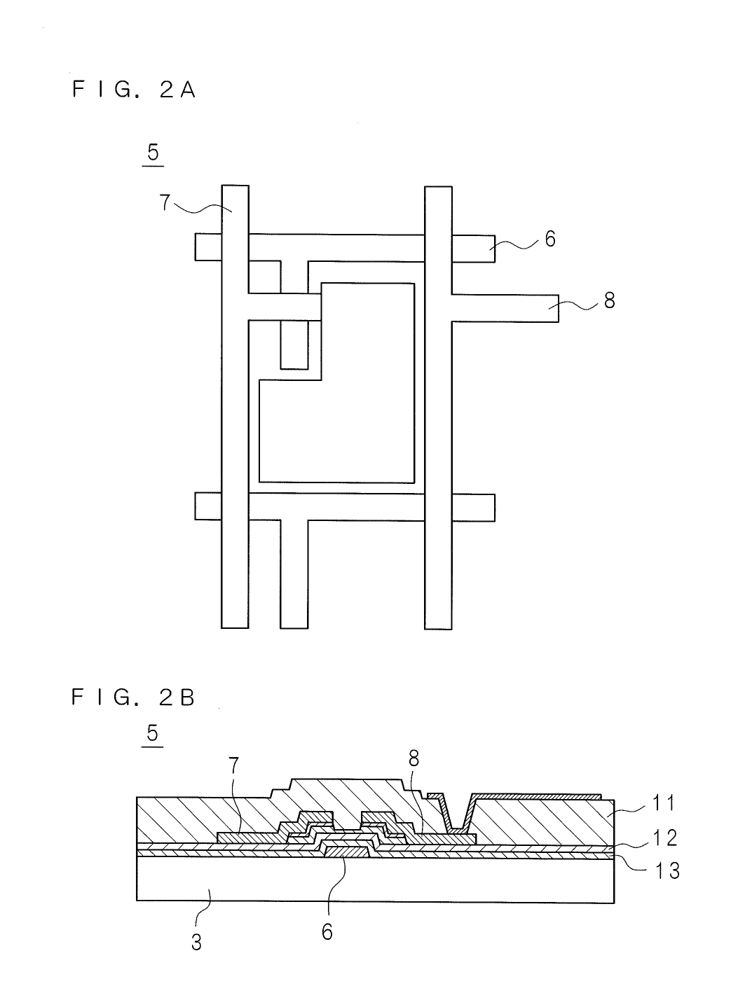

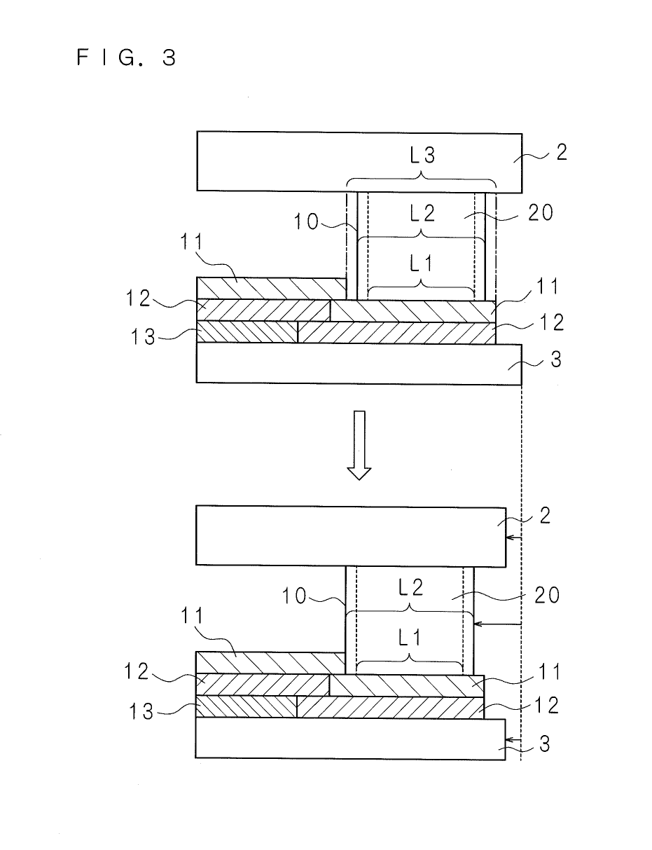

FIG. 1 is a plan view and a cross-sectional view of an entire liquid crystal panel according to one embodiment of the present invention, FIGS. 2A and 2B are a partial plan view and a partial cross-sectional view taken on line A-A′ of FIG. 1 for illustrating a TFT structure, and FIG. 3 is cross-sectional views taken on line B-B′ of FIG. 1 for describing narrowing of the frame in the liquid crystal panel in the periphery of a region in which a seal is formed. As illustrated in FIG. 1, a liquid crystal panel 1 includes an upper substrate 2 and a lower substrate 3 which face each other at a prescribed distance, and a liquid crystal material is sealed and held therebetween by a seal (sealing body) which seals an opposing gap between the both substrates. In addition, the seal is formed in a frame shape at peripheral edge parts on the substrates. In the case of an active matrix type liquid crystal display apparatus, the upper substrate 2 is a color filter substrate forming a color filter, a counter electrode, and the like, and the lower substrate 3 is a TFT substrate forming a TFT, a pixel electrode and the like. FIG. 1 illustrates a pixel region 4, and the pixel region 4 has one conductive layer including a plurality of scanning lines, and the other conductive layer including a plurality of signal lines which intersect the one conductive layer through an insulation layer.

That is, the two conductive layers are signal line layers formed on the lower substrate 3 through the insulation layer. The TFT for switching each pixel is respectively formed in the vicinity of a portion in which the scanning line and the signal line intersect. Hereinafter, the case in which the present embodiment is applied to the active matrix type liquid crystal display apparatus will be described, but it may be applied to another display apparatus such as a plasma display.

As illustrated in FIG. 2A or 2B, a TFT 5 mainly includes three electrodes of a gate electrode 6, a source electrode 7 and a drain electrode 8, a gate insulation layer 12, and amorphous silicon in which a current flows. The gate electrode 6 is connected to the scanning line, the source electrode 7 and the drain electrode 8 are connected to the signal line, and the drain electrode 8 and the source electrode 7 are connected to a transparent electrode for driving the liquid crystal, respectively. As illustrated in FIG. 2B, the gate electrode 6 is formed, on the lower substrate 3, of elementary metal such as Cu, or Ti, etc., or a material which contains nitrogen, oxygen, or other metal in the elementary metal. Next, an interwire insulation layer 13 and a gate insulation layer 12 are sequentially formed on the gate electrode 6, and an amorphous silicon (a-Si: amorphous silicon) layer which is a semiconductor active layer is formed thereon. Further, an a-Si layer with N+ impurities mixed therein for reducing a joining resistance is formed thereon. Then, the source electrode 7 and the drain electrode 8 are formed by the same material as the gage electrode, and an interlayer insulation layer 11 for protecting the amorphous silicon layer, the source electrode 7 and drain electrode 8 is formed thereon.

Accordingly, a first signal line layer which is the one conductive layer including the plurality of scanning lines, and a second signal line layer which is the other conductive layer including the plurality of signal lines through the interwire insulation layer 13 and the gate insulation layer 12 are provided on the lower substrate 3.

The signal line and the TFT 5 have an organic interlayer insulation film, and the like formed thereon as the interlayer insulation layer 11. In the present embodiment, the interlayer insulation layer 11 is formed in a single layer structure, but it is not limited thereto, and the interlayer insulation layer may be formed in a multi-layer structure using a passivation film or the like.

The gate electrode 6, that is, the insulation layer covering the scanning line is configured in a multi-layer insulation layer including the gate insulation layer 12 and the interwire insulation layer 13. The gate insulation layer 12 may be formed of a silicon oxide film (SiOx), a silicon nitride film (SiNx) or the like. The interwire insulation layer 13 may be formed of a spin-on-glass (SOG) material or the like. The interwire insulation layer 13 is disposed below the gate insulation layer 12, such that a parasitic capacitance due to the portion in which the scanning line and the signal line intersect may be reduced.

The SOG material used as the material of the interwire insulation layer 13 is a material capable of forming a glass film (silica-based coating film) by using a coating method such as a spin coating method. In particular, an organic SOG material having a Si—O—C bond as a skeleton, or an organic SOG material having a Si—C bond as a skeleton may be used. Since the organic SOG material has a low relative permittivity, and is easy to form a thick film, it is easy to decrease the relative permittivity of the interwire insulation layer 13 and form the interwire insulation layer 13 with an increased thickness by using the organic SOG material.

In order to reduce the parasitic capacitance due to the portion in which the scanning line and the signal line intersect, it is preferable that the gate insulation layer 12 is thinner than the interwire insulation layer 13. Preferably, the gate insulation layer 12 has a thickness of about 0.2 μm to 0.4 μm, and the interwire insulation layer 13 has a thickness of about 0.5 μm to 4.0 μm. Further, in order to reduce the parasitic capacitance due to the portion in which the scanning line and the signal line intersect, it is preferable that the gate insulation layer 12 has the relative permittivity higher than that of the interwire insulation layer 13. Preferably, the gate insulation layer 12 has the relative permittivity of about 5.0 to 8.0, and the interwire insulation layer 13 has the relative permittivity of 4.0 or less.

In the present embodiment, the gate insulation layer 12 is formed so as to cover the interwire insulation layer 13, but it is not limited thereto. In a part of the region in which the TFT 5 is formed, only the gate insulation layer 12 may be formed without forming the interwire insulation layer 13. For example, the interwire insulation layer 13 may be formed on the entire panel other than the portions such as elements and contacts. In addition, the interwire insulation layer 13 may be formed so as to correspond to the scanning line and the signal line of the pixel region 4, in order to mitigate the parasitic capacitance.

FIG. 3 is cross-sectional views taken on line B-B′ of FIG. 1 for describing narrowing of the frame in the liquid crystal panel in the periphery of the region in which the seal is formed. Hereinafter, a method of narrowing the frame in the liquid crystal panel by decreasing the seal width to a level that the seal is not easily broken will be described.

As illustrated in FIG. 3, the upper substrate 2 and lower substrate 3 are bonded to each other by a seal 10 through the insulation layer in a direction in which the substrates face each other. The upper substrate 2, the seal 10, the interlayer insulation layers 11, the gate insulation layers 12 and the lower substrate 3 are disposed in this order from the top of FIG. 3. In addition, the seal 10 includes a seal material adhering region 20. The seal material adhering region 20 is a region in which the seal material is adhered to the peripheral edge parts of the substrates during forming the seal 10, and corresponds to the region surrounded by dotted lines between the upper substrate 2 and the interlayer insulation layer 11. For example, the seal material adhering region 20 corresponds to the region in which the seal material is drawn by a dispenser. Further, the seal 10 is formed in a seal forming region surrounded by solid lines between the upper substrate 2 and the interlayer insulation layer 11. After the seal material is adhered to the peripheral edge parts of the substrates, the upper substrate 2 and the lower substrate 3 are bonded to each other, and then the seal material spreads in a direction perpendicular to the direction in which the seal material is adhered, that is, in a left-right direction of FIG. 3, such that the seal 10 is formed between the both substrates. Symbol L1 denotes the width of the seal material adhering region 20 in the direction perpendicular to the direction in which the seal material is adhered, and symbol L2 denotes the width of the seal forming region in the direction perpendicular to the direction in which the seal material is adhered. That is, a difference (L2-L1) in the two widths denotes a width in which the seal material spreads in the direction perpendicular to the direction in which the seal material is adhered, when bonding the upper substrate 2 and the lower substrate 3 to each other.

The interwire insulation layer 13 is formed as the insulation layer for reducing the parasitic capacitance due to the portion in which the scanning line and the signal line intersect in the pixel region 4, but it is not formed below the seal 10. In other words, among the insulation layer formed between the conductive layer (a first signal line layer) including the scanning line and the conductive layer (a second signal line layer) including the signal line, only the gate insulation layer 12 is formed below the seal 10 continuously from the pixel region 4. Herein, the width L3 in the seal forming region of the case, in which the interlayer insulation layer 11, the gate insulation layer 12, the interwire insulation layer 13 and the lower substrate 3 are disposed below the seal 10 in this order from the top as the prior art, is illustrated by one-dot chain lines on the upper side of FIG. 3. In this case, it is possible to more decrease the width L2 in the seal forming region in which the interwire insulation layer 13 is not formed than the width L3 in the seal forming region in which the interwire insulation layer 13 is formed, depending on the volume of the interwire insulation layer 13 which is not formed below the seal 10. That is, even when more decreasing the width L2 than the width L3, the seal 10 may be formed so that the entire volume of the seal 10 is not changed, and thereby it is possible to reduce the width thereof to a level that the seal 10 is not easily broken. In addition, since the seal 10 is formed with the width L2 smaller than the width L3 so that the entire volume of the seal 10 is not changed, it is possible to decrease the width in which the seal material spreads when bonding the upper substrate 2 and the lower substrate 3 to each other.

Therefore, as illustrated on the lower side of FIG. 3, it is possible to narrow the frame which is an outer peripheral part other than the pixel region of the liquid crystal panel 1. In addition, due to narrowing the frame of the liquid crystal panel 1, it is possible to provide a liquid crystal display apparatus with a decreased external size. Meanwhile, since the interwire insulation layer 13 which is not formed below the seal forming region is formed as one insulation layer in the pixel region 4, the thickness of the insulation layer at the portion in which the scanning line and the signal line intersect is sufficiently thickened, and thereby the parasitic capacitance due to the intersection portion is reduced. According to the liquid crystal display apparatus of the present embodiment, by decreasing the seal width to a level that the seal is not easily broken, it is possible to narrow the frame of the liquid crystal panel, and reduce the influence of the parasitic capacitance due to the portion in which the scanning line and the signal line intersect.

For example, when the width L3 of the case in which the interwire insulation layer 13 is formed below the seal forming region as the prior art is 1.0 mm, and a cross-section of the seal (an area surrounded by the solid lines between the upper substrate 2 and the interlayer insulation layer 11 in the seal 10) is 4000 μm², if the interwire insulation layer 13 having a thickness of 0.5 μm is not disposed below the seal forming region as the present invention, it is possible to narrow the frame of the liquid crystal panel about 0.1 mm (1.0−4000+(4+0.5)). Therefore, it is possible to secure the volume of the seal 10 so as to ensure the seal is not easily broken, and narrow the frame of the liquid crystal panel.

When drawing the seal with a required minimum width of 1.2 mm which is a target width other than the interwire insulation layer 13 as a target, the width of the seal forming region becomes to be 2.26 mm considering the seal slippage and spread. Therefore, when not forming the interwire insulation layer 13 over the entirety of below the seal forming region, it is preferable that an area ratio of the region in which the interwire insulation layer 13 is not formed to an entire sealing region is set to 53% or more.

A process of manufacturing the liquid crystal panel according to one embodiment of the present invention will be described below. The upper substrate 2 which is the color filter substrate, and the lower substrate 3 which is the TFT substrate are prepared. As a step of fabricating the lower substrate 3, the gate electrode 6 is formed on the substrate. Next, the interwire insulation layer 13 and the gate insulation layer 12 are formed on the gate electrode 6, and an amorphous silicon layer is formed thereon. Further, an amorphous silicon layer with N+ impurities mixed therein is formed thereon. Then, the source electrode 7 and the drain electrode 8 are formed, and the interlayer insulation layer 11 for protecting the amorphous silicon layer, the source electrode 7 and drain electrode 8 is formed thereon. When fabricating the TFT substrate, a sputtering method, a photolithographic method, an etching method, and the like, which are known in the art, may be applied.

The interwire insulation layer 13 is formed of an SOG material, and the gate insulation layer 12 is formed of a silicon oxide film (SiOx), a silicon nitride film (SiNx) or the like. The interlayer insulation layer 11 and the gate insulation layer 12 are formed so as to be disposed below the seal 10 along the entirety of the lower substrate 3 and the four sides on the lower substrate 3. An etching method, or the like may be applied to the insulation layer laminated on the lower substrate 3, so that the interlayer insulation layer 11 and the gate insulation layer 12 are disposed below the seal 10. The interlayer insulation layer 11 and the gate insulation layer 12 are formed along the four sides on the lower substrate 3, such that a height of the entire liquid crystal panel 1 after the upper substrate 2 and the lower substrate 3 are bonded to each other may be uniform. The interlayer insulation layer 11 may not be formed below the seal 10. However, if the interlayer insulation layer 11 having a relatively thick thickness among the insulation layers formed on the lower substrate 3 is not formed below the seal 10, since a lead-out wire for connecting from a terminal to the pixel region 4 is disposed below the seal 10, the lead-out wire is likely to be leaked to the counter electrode, or the like through a conductive space, or the like in the seal 10. Therefore, it is preferable that the interlayer insulation layer 11 is formed below the seal 10.

After the upper substrate 2 and the lower substrate 3 are prepared, the both substrates are cleaned and an alignment treatment is executed thereon. The seal material is applied to the seal material adhering region 20 of the peripheral edge part of the upper substrate 2 or the lower substrate 3 on which the alignment treatment is executed using screen printing or a dispenser. When drawing the seal material using the dispenser, as the seal material, an ultraviolet curable resin, a visible light curable resin or a paste-like one-component thermosetting resin may be used. Due to the correspondence to the dispenser, it is preferable to use the ultraviolet curable resin or the visible light curable resin, which can be harden at a low temperature without a solvent. In addition, as a specific resin type, for example, there may be an acrylate resin or an epoxy resin. The seal material may contain granular spacers other than the resin component and polymerization initiator, as necessary. For example, the line width of the seal material to be drawn is 0.1 to 2.0 mm.

After the seal material is adhered to the substrates, by facing the upper substrate 2 and the lower substrate 3 with each other, these substrates are optically aligned using an alignment mark, and then the seal material is hardened. Thereafter, the liquid crystal panel is manufactured through a liquid crystal dropping and bonding process, a substrate cutting process, a deflection plate attaching process and the like.

### Embodiment 2

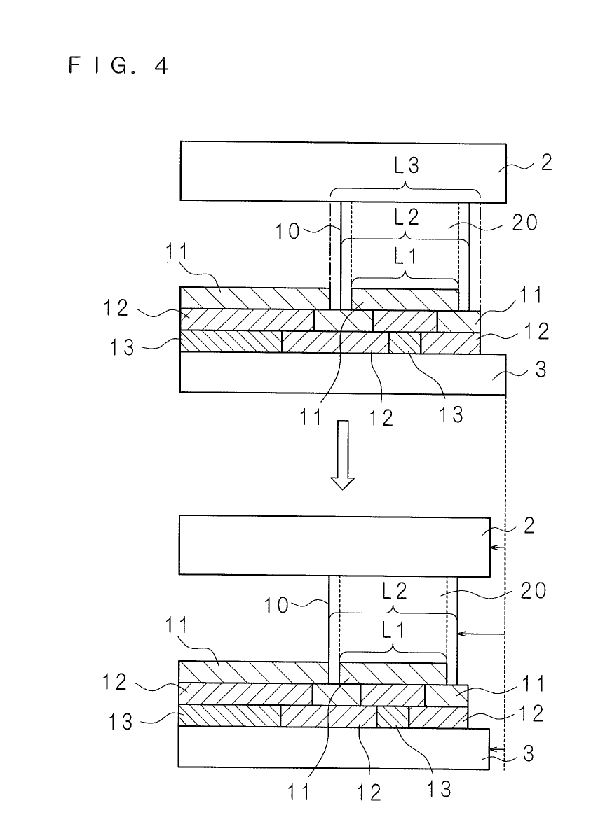

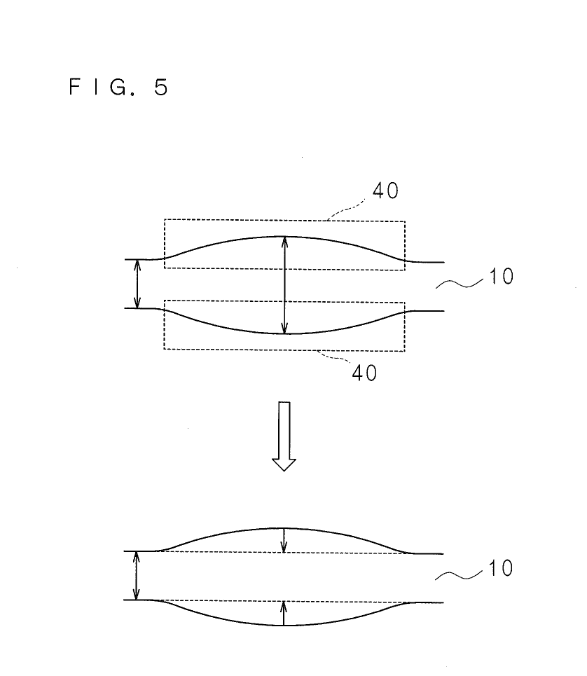

The structure in the pixel region of the Embodiment 2 is the same as that of Embodiment 1, and therefore will not be described in detail. FIG. 4 is cross-sectional views for describing narrowing of the frame in a liquid crystal panel in the periphery of a seal connecting part according to another embodiment of the present invention, and FIG. 5 is views for describing the seal connecting part. Hereinafter, a method of narrowing the frame in the liquid crystal panel by decreasing the seal width to a level that the seal is not easily broken in the seal connecting part will be described.

The seal connecting part is a seal material adhering region 20 and corresponds to a joining part of a start point and an end point when adhering the seal material. For example, when drawing the seal material in a frame shape along the peripheral edge part of an upper substrate 2 or a lower substrate 3, the seal connecting part corresponds to a joining part of the start point and the end point for drawing the seal material.

As illustrated in FIG. 4, the upper substrate 2 and the lower substrate 3 are bonded to each other by a seal 10 through an insulation layer in a direction in which the substrates face each other, the upper substrate 2, the seal 10, interlayer insulation layers 11, gate insulation layers 12 disposed between the interlayer insulation layers 11, interwire insulation layers 13 disposed between the gate insulation layer 12, and the lower substrate 3 are disposed in this order from the top of FIG. 4. In addition, the seal 10 includes the seal material adhering region 20. The seal material adhering region 20 is a region in which the seal material is adhered to the peripheral edge parts of the substrates, and corresponds to the region surrounded by the dotted lines between the upper substrate 2 and the interlayer insulation layer 11. Further, the seal 10 is formed in the seal forming region surrounded by the solid lines between the upper substrate 2 and the interlayer insulation layer 11. After the seal material is adhered to the peripheral edge parts of the substrates, the upper substrate 2 and the lower substrate 3 are bonded to each other, and then the seal material spreads in a direction perpendicular to the direction in which the seal material is adhered, that is, in a left-right direction of FIG. 4, such that the seal 10 is formed between the both substrates. Symbol L1 denotes the width in the seal material adhering region 20 in the direction perpendicular to the direction in which the seal material is adhered, and symbol L2 denotes the width in the seal forming region in the direction perpendicular to the direction in which the seal material is adhered. That is, a difference (L2-L1) in the two widths denotes the width in which the seal material spreads in the direction perpendicular to the direction in which the seal material is adhered, when bonding the upper substrate 2 and the lower substrate 3 to each other.

The interwire insulation layer 13 is formed as the insulation layer for reducing the parasitic capacitance due to the portion in which the scanning line and the signal line intersect in the pixel region 4, but it is configured in such a manner that, when bonding the upper substrate 2 and the lower substrate 3 are bonded to each other, the interwire insulation layer 13 is not disposed at a region which corresponds to the width in which the seal material spreads in the direction perpendicular to the direction in which the seal material is adhered, that is, in the left-right direction of FIG. 4. Herein, the width L3 in the seal forming region of the case, in which the interlayer insulation layers 11, the gate insulation layers 12, the interwire insulation layer 13 and the lower substrate 3 are disposed below the seal 10 in this order from the top as the prior art, is illustrated by the one-dot chain lines on the upper side of FIG. 4. In this case, it is possible to more decrease the width L2 in the seal forming region in which the insulation layer is not formed than the width L3 in the seal forming region in which the insulation layer is formed, depending on the volume of the insulation layer which is not formed below the seal 10. That is, even when more decreasing the width L2 than the width L3, the seal 10 may be formed so that the entire volume of the seal 10 is not changed, and thereby it is possible to reduce the width thereof to a level that the seal 10 is not easily broken. In addition, since the seal 10 is formed with the width L2 smaller than the width L3 so that the entire volume of the seal 10 is not changed, it is possible to decrease the width in which the seal material spreads when bonding the upper substrate 2 and the lower substrate 3 to each other.

Further, in the present embodiment, the insulation layer is not disposed at a region which is below a seal connecting part 40 and corresponds to the width in which the seal material spreads when bonding the upper substrate 2 and the lower substrate 3 to each other. That is, the number of layers of the insulation layers is decreased from three layers to two layers in the vicinity of an outer peripheral part and the vicinity of an inner peripheral part of the seal 10. As illustrated in FIG. 5, since the seal connecting parts 40 correspond to the joining part of the start point and the end point are bound to each other when adhering the seal material, the seal material is formed to be overlapped. Therefore, since a large amount of the seal material is adhered in the seal connecting parts 40, the width in which the seal material spreads is large among the seal material adhering region 20. When configuring the periphery of the seal connecting parts 40 in an arrangement of the insulation layer as illustrated on the upper side of FIG. 4, since the seal connecting part 40 having a large width in which the seal material spreads is sandwiched between the upper substrate 2 and the interlayer insulation layer 11, and the insulation layer is not disposed at the region corresponding to the width in which the seal material spreads, when bonding the upper substrate 2 and the lower substrate 3 to each other, the seal material is uniform in the seal connecting part 40, and thereby the width in which the seal material spreads may be suppressed.

Conventionally, when sealing both substrates through the seal, it is necessary to design a gap from the peripheral edge part of the liquid crystal panel to the seal by matching with the width of the seal connecting part. However, when configuring the periphery of the seal connecting part in the arrangement of the insulation layer as in the present embodiment, since the width in which the seal material spreads can be suppressed, there is no need to design as described above. For example, when bonding the upper substrate 2 and the lower substrate 3 to each other, if a length of the seal connecting part 40 in a drawing direction thereof is 20 mm by increasing by 30% a ratio of the seal width of the seal connecting part to the seal width other than the seal connecting part, a ratio of the portion in which the insulation layer is partially removed to the entire sealing region is 0.48% of the entire sealing region. Thereby, it is preferable that the ratio of the portion in which the insulation layer is partially removed is 0.48% or more of the entire sealing region.

Accordingly, as illustrated on the lower side of FIG. 4, it is possible to narrow the frame which is the outer peripheral part other than the pixel region of the liquid crystal panel 1. In addition, due to narrowing the frame of the liquid crystal panel 1, it is possible to provide a liquid crystal display apparatus with a decreased external size. Meanwhile, since the interwire insulation layer 13 which is not disposed the region which is below the seal connecting part 40 and corresponds to the width in which the seal material spreads is formed as one insulation layer in the pixel region 4, the thickness of the insulation layer at the portion in which the scanning line and the signal line intersect is sufficiently thickened, and thereby the parasitic capacitance due to the intersection portion is reduced. According to the liquid crystal display apparatus of the present embodiment, by decreasing the seal width to a level that the seal is not easily broken, it is possible to narrow the frame of the liquid crystal panel, and reduce the influence of the parasitic capacitance due to the portion in which the scanning line and the signal line intersect.

In the present embodiment, the structure illustrated in FIG. 4 is applied to only the seal connecting part 40, but it is not limited thereto, and the structure illustrated in FIG. 4 may be applied to all the region in which the seal is formed.

### Embodiment 3

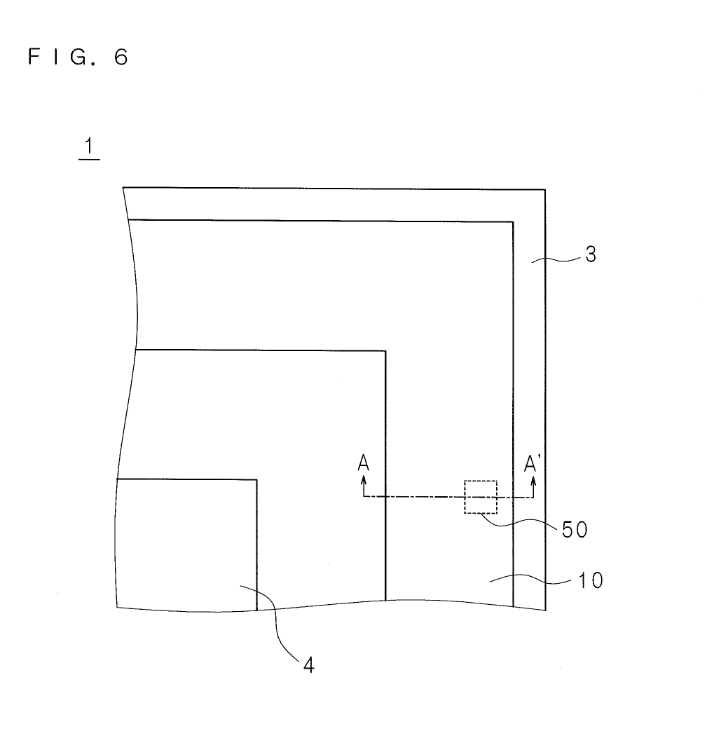

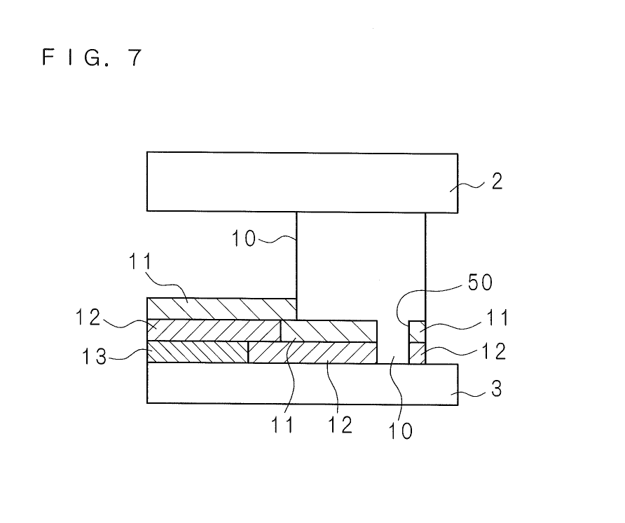

The structure in the pixel region, and the structure of narrowing the frame of the liquid crystal panel 1 by the alignment of the insulation layer below a seal 10 of the Embodiment 3 are the same as those of Embodiment 1, and therefore will not be described in detail. FIG. 6 is a partial plan view of a lower substrate and the seal according to another embodiment of the present invention, and FIG. 7 is a cross-sectional view taken on line A-A′ of FIG. 6 for illustrating the periphery of the region in which the seal is formed. As mentioned in Embodiment 1, an interwire insulation layer 13 is formed as the insulation layer for reducing the parasitic capacitance due to the portion in which the scanning line and the signal line intersect in the pixel region 4, but it is not formed below the seal 10, and therefore, it is possible to reduce the width thereof to a level that the seal 10 is not easily broken. In addition, since the seal 10 is formed with the width L2 smaller than the width L3 so that the entire volume of the seal 10 is not changed, it is possible to decrease the width in which the seal material spreads when bonding an upper substrate 2 and a lower substrate 3 to each other. Therefore, it is possible to narrow the frame which is the outer peripheral part other than the pixel region of the liquid crystal panel 1. According to present embodiment, by decreasing the seal width to a level that the seal is not easily broken, it is possible to narrow the frame of the liquid crystal panel, and provide the liquid crystal display apparatus capable of reducing the influence of the parasitic capacitance due to the portion in which the scanning line and the signal line intersect.

In the present embodiment, in addition to the configuration of Embodiment 1, as illustrated in FIG. 7, a hole 50 is opened in a part of an interlayer insulation layer 11 and a gate insulation layer 12 which are disposed below the seal 10, such that the seal 10 is in direct close contact on the lower substrate 3. Generally, since the adhesion strength with respect to the seal 10 depends on the material to be in close contact, the adhesion strength between the seal 10 and the lower substrate 3, for example, the adhesion strength with the glass substrate is higher than the adhesion strength between the seal 10 and the interlayer insulation layer 11. Therefore, the hole 50 is opened in the part of the interlayer insulation layer 11 and the gate insulation layer 12 which are disposed below the seal 10, and the seal 10 and the lower substrate 3 are directly in close contact with each other, such that it is possible to increase the adhesion strength of the seal 10.

When opening the hole 50 in the part of the interlayer insulation layer 11 and the gate insulation layer 12, any method known in the art may be applied. An etching method and/or a photolithographic method may be applied, and the hole 50 may be formed in the part of the interlayer insulation layer 11 and the gate insulation layer 12 by using a laser beam. When increasing size of the hole 50 formed in the part of the interlayer insulation layer 11 and the gate insulation layer 12, the adhesion strength between the seal 10 and the lower substrate 3 may be increased. However, since a lead-out wire for connecting from a terminal to the pixel region is disposed below the seal 10, a metal wire is likely to be leaked to the counter electrode through a conductive space in the seal. Therefore, it is preferable that a metal pattern such as the wire or the conductive layer is not present around the formed hole 50.

In the present embodiment, in order to increase the adhesion strength between the seal 10 and the lower substrate 3, the hole 50 is opened in the part of the interlayer insulation layer 11 and the gate insulation layer 12 which are disposed under the seal 10, in relation to all of the region in which the seal 10 is formed, but it is not limited thereto. The hole 50 may be opened in the part of the interlayer insulation layer 11 and the gate insulation layer 12 which are disposed under the seal 10, in relation to a part of the region in which the seal 10 is formed. In addition, the structure illustrated in FIG. 7 may be applied to the parts other than the seal connecting part 40, and the structure illustrated in FIG. 4 may be applied to the seal connecting part 40.

It should be understood that the embodiments disclosed herein are illustrative and non-restrictive in every respect. Since the scope of the present invention is defined by the appended claims rather than by the description preceding them, and all changes that fall within metes and bounds of the claims, or equivalence of such metes and bounds thereof are therefore intended to be embraced by the claims.

As this invention may be embodied in several forms without departing from the spirit of essential characteristics thereof, the present embodiments are therefore illustrative and not restrictive, since the scope of the invention is defined by the appended claims rather than by the description preceding them, and all changes that fall within metes and bounds of the claims, or equivalence of such metes and bounds thereof are therefore intended to be embraced by the claims.

1-10. (canceled)

11. A display apparatus comprising:
two substrates which face each other;
a first signal line layer provided on one substrate of the two substrates;
a second signal line layer provided on the first signal line layer through a plurality of first insulation layers; and
a sealing body which is provided on a peripheral edge part of the one substrate through one or a plurality of second insulation layers having the number of layers less than the number of layers of the first insulation layer, and seals an opposing gap between the two substrates.

12. The display apparatus according to claim 11, wherein the second insulation layer is formed on the peripheral edge part of the one substrate continuing to the first insulation layer.

13. The display apparatus according to claim 11, wherein an insulation layer which is located on the one substrate side among the first insulation layers is formed of a spin-on-glass (SOG) material.

14. The display apparatus according to claim 11, wherein the one substrate is formed in a rectangular shape, and the second insulation layer is formed along four sides of the substrate.

15. The display apparatus according to claim 11, wherein the sealing body is formed in a frame shape, and
the number of layers of the first insulation layer is more than the number of layers of the second insulation layer in the vicinity of an outer peripheral part and the vicinity of an inner peripheral part of the sealing body.

16. The display apparatus according to claim 15, wherein a ratio of a portion in which the insulation layer is removed in the vicinity of the outer peripheral part and the vicinity of the inner peripheral part of the sealing body is 0.48% or more of an entire region formed by the sealing body.

17. The display apparatus according to claim 11, wherein the second insulation layer has a hole formed therein to contact the sealing body with the substrate.

18. The display apparatus according to claim 17, wherein a conductive layer is not disposed around the hole.

19. The display apparatus according to claim 11, wherein the first insulation layer is formed in three layers.

20. A display apparatus comprising:
two substrates which face each other;
a first signal line layer provided on one substrate of the two substrates;
a second signal line layer provided on the first signal line layer through a plurality of first insulation layers;
one or a plurality of second insulation layers provided between the second signal line layer and the other substrate; and
a sealing body which is provided on a peripheral edge part of the one substrate through a third insulation layer having the number of layers less than the number of layers obtained by adding the first insulation layer and the second insulation layer, and seals an opposing gap between the two substrates.
